(19) United States
(12) Patent Application Publication
(10) Pub. No.: US 2021/0191443 A1
(43) Pub. Date: Jun. 24, 2021

(54) INLINE ADAPTER MODULE FOR PROVIDING VENDED POWER SOURCE

(71) Applicant: THE HARVEST COLLECTIVE LLC (DBA SHINEPAY), Oakland, CA (US)

(72) Inventors: George William Melcer, Oakland, CA (US); Charles Karim Aweida, Oakland, CA (US)

(21) Appl. No.: 16/723,189

(22) Filed: Dec. 20, 2019

(51) Int. Cl. G05F 1/66; G06Q 30/06; G06Q 20/30

(52) U.S. Cl. CPC G05F 1/66; G06Q 20/30; G06Q 30/06

(57) ABSTRACT

Techniques for providing electric power are disclosed. In one aspect, an adapter module is retrofit inline with an existing power source for moderating the supply of power via an outlet. In response to receiving a confirmation that a wireless payment has been tendered, the module automatedly activates a switch to provide power to an identified outlet for a predetermined time or until the user device is charged. In another aspect, an adapter module provides a power or data service responsive to information provided by a user via a mobile application. In either case using the retrofit adapter module, payments can be made available using existing infrastructures with only the need for the adapter module.

### BACKGROUND

### Field

The present disclosure relates generally to vending industries, and more specifically to techniques for augmenting existing devices for providing power services.

### Background

In today's automated vending marketplace, mobile devices and online payment techniques have become ubiquitous. As e-commerce offers newer and more convenient payment options to the consumer for obtaining products and services, a corresponding litany of advanced vending appliances have become available for enabling credit card and other wireless transactions. Meanwhile, the large number of existing coin-operated vending machines have become increasingly antiquated.

To meet with this rising consumer demand for newer vending services and more flexible payment options while continuing to exact revenue for their services, practitioners in the art have developed new vending machines that accept credit cards and other mobile-device initiated forms of payment. Various snack and soda machines, for example, have been manufactured to integrate wireless payment capabilities. Similarly, dedicated cellular phone charging kiosks have been implemented in airports and other environments so that vendors can continue to receive revenue from their patrons. Sophisticated vehicle charging stations may enable property owners to acquire additional revenue, provided that the property owner has the capital and the requisite customer numbers to acquire these resources. In addition, certain existing infrastructures that may be present at consumer-frequented businesses, such as power outlets, generally have no capabilities for revenue generation, resulting in potentially missed financial opportunities for the business.

One drawback in conventional existing power sources solutions is that to augment them with additional capability to accept alternative forms of payment as a condition for use, the enabling technology typically must be built from the ground up. Acquiring new machines for these services can be cost-prohibitive, particularly for many small businesses. These new machines include providing electric power or charging stations built from the ground up to assess a fee. While costly new devices have been showcased to serve as prospective alternatives to standard wall outlets for passing the fees for using the power source to customers, the devices themselves are often too expensive to merit their acquisition.

The present disclosure addresses these and other shortcomings in the art.

### SUMMARY

Various aspects of the disclosure are set forth herein. According to one aspect of the disclosure, a method for providing a power source for a user device includes retrofitting an adapter module inline with the power source, the adapter module including a switch that, when off, maintains an outlet corresponding to the power source in a disabled state, receiving, from the user over a network, confirmation that an electronic payment has been tendered to enable the outlet, and activating automatically the switch to an on position in response to the confirmation to thereby enable a current to be received by the user device coupled to the outlet.

According to another aspect of the disclosure, an adapter module retrofit inline with a power source for providing power to a user device includes a processing system for controlling a switch that, when off, maintains an outlet of the power source in a disabled state, and a wireless transceiver coupled to the processing system for receiving confirmation from a user over a network that an electronic payment has been tendered to enable the power source, wherein the processing system automatically activates the switch to an on position based on the received confirmation to thereby enable a flow of current to be received by the user device coupled to the outlet.

According to still another aspect of the disclosure, a method for providing a product or service to a user includes retrofitting an adapter module with an automated vending device providing the product or service, the adapter module comprising a switch that, when off, maintains the vending device in an idle state, receiving, from a user device over a network, information comprising an indication that an electronic payment has been tendered and a desired product or service, and activating the switch responsive to the information to enable providing, by the vending device, the product or service.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### DESCRIPTION OF THE DRAWINGS

FIG. 1 is a block diagram of an adapter module for retrofitting inline with a power source, in accordance with an embodiment.

FIG. 2 is a flow diagram describing a process for using the adapter module to receive a vend, in accordance with an embodiment.

FIG. 3A is an illustration of a power source that a user can access via a mobile device application to power a user device.

FIG. 3B is a flow diagram of a method for installing and operating an adapter module with the power source of FIG. 3A.

FIG. 4 is an illustration of an open power source with an adapter module retrofit inline therewith, in accordance with an embodiment.

FIG. 5A-J are a flow diagram depicting features on a mobile device for enabling a user to receive a vended product or service, in accordance with an embodiment.

FIG. 6 is a conceptual block diagram that identifies differences between the adapter module and existing power source in accordance with an embodiment.

### DETAILED DESCRIPTION

The detailed description set forth below in connection with the appended drawings is intended to provide a description of various exemplary embodiments and is not intended to represent the only embodiments in which the invention may be practiced. The terms “exemplary” and “example(s)” used throughout this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The present disclosure is generally directed to apparatuses and techniques for providing services to users of mobile devices, including more specifically, electric power, whether as a standard North American outlet or a dedicated DC charging plug, and the like. The techniques can be implemented as a combination of a mobile application for enabling consumers to communicate easily with the vendor as well as an adapter module that can be retrofitted inline with existing equipment to authorize and execute wireless transactions without need for a new machine. Among other features and benefits, the adapter module enables an owner of a vending machine or an electric outlet to charge users for the use of the corresponding power using credit, debit, and other wireless payment methods programmed into a mobile application developed for use with the adapter module. In an embodiment, the mobile application can provide means for the consumer to access an account to which the consumer can easily add funds to obtain services at authorized power vending stations.

In various embodiments, the adapter modules obviate the need for the vendor to purchase all new equipment for its existing infrastructures, much of which may be distributed about a larger geographical region. Instead, the vendor can purchase the adapter modules described herein and can easily install the adapter modules at locations where an existing power source is present. The owner can place conspicuous messages adjacent the power sources with instructions to a prospective consumer for downloading and installing a mobile application that the prospective consumer can use to tender wireless payments in exchange for use of the power, e.g., for a predetermined time. These embodiments are described further below.

Other than acquiring a single adapter module to correspond to a given power source and implementing a straightforward retrofit using the adapter module in an existing wall unit or machine as described herein, the disclosed techniques may advantageously obviate the need for the product or service vendor to make significant capital investments to acquire equipment manufactured from scratch. In particular, the vendor may simply retrofit the adapter module into an existing power source to make a commercial solution realizable. In connection with the adapter module, an algorithm for a mobile application is disclosed for enabling a user of a mobile device to communicate wirelessly over one or more networks with external services as well as the adapter module itself to receive authorization to use the power source at issue.

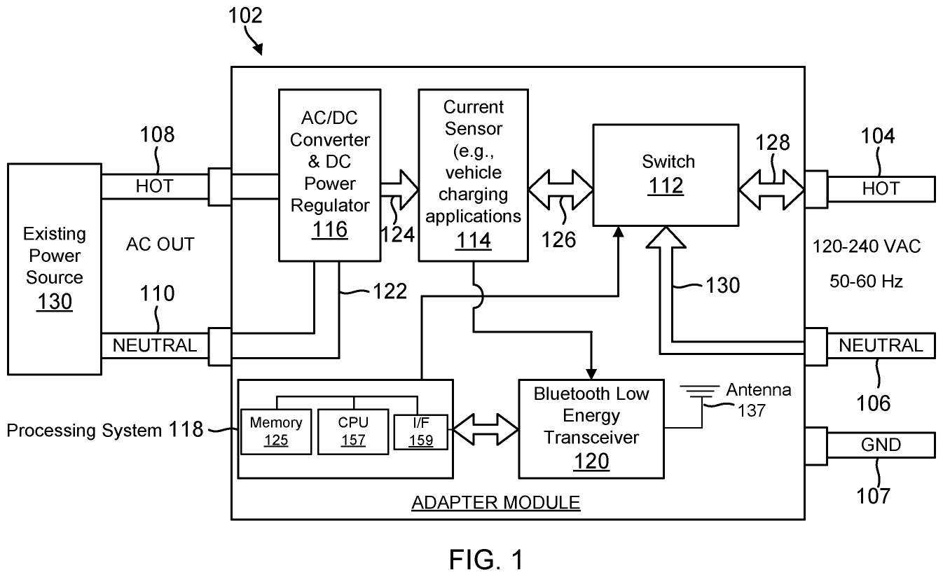

FIG. 1 is a block diagram of an adapter module 102 for retrofitting inline with an existing power source 130, in accordance with an embodiment. The power source may be a DC or AC power source and may use any of a variety of existing standards. In the embodiment shown, the power source is a standard AC power source having a hot wire 108 for carrying current to an outlet and a neutral wire 110 to provide a return path for the current, and a ground wire. For three-pronged outlets, a ground contact may also be provided. The adapter module 102 may include one or more printed circuit boards having integrated circuits connected thereto, such as filters, diodes, amplifiers, etc., for implementing dedicated functions. The specific configuration of the adapter module 102 is likely to depend on part on the type of power source (e.g., the standard, the nature and magnitude of the voltage, etc.)

In an embodiment, the hot and neutral wires 108 and 110 that are part of the existing outlet may be coupled with adapter module 102 to an AC/DC converter and DC power regulator 116, in cases where a DC voltage and current is desired at the adapter module output. In other embodiments, the standard AC voltage (which can be filtered or otherwise fed directly through the adapter module 102) can be provided at the output. Additional or different elements including filters or amplifiers to increase signal-to-noise ratio may also be used, but may not be necessary for a simple power source.

The output of the power source 130 can in another embodiment be provided via conductor 124 to a current sensor 114. The current sensor 114 may be used in some embodiments to measure a value of the current flow to and/or from a user device connected to the power source, which in turn can be used to ascertain the amount or percentage that a connected user device has been charged. The current sensor 114 is optional, and in other embodiments other or different functions may be implemented.

The wires 108 and 110 from one or both of existing power source 130 may be provided via bus 126 to a switch 112, which has conductor 128 as an output. In various embodiments, the switch 112 may be a simple transistor or the like, or it may be a more sophisticated processor controlled switch that can be activated on to an ENABLED condition to thereby allow current to flow to a connected user device, or it can be switched off to a DISABLED condition until it is activated as described further below. The switch 112 may be any standard or custom switch (or plurality thereof), and the actual configuration of hardware may vary depending on the standard used and the type of power supplied. In some embodiments, different switches may be provided, e.g., for multiple power outlets from the same existing power source 130. The switch may be coupled to respective hot and neutral outputs 104 and 106 via conductor 128. In various embodiments, conductor may be coupled to a neutral wire 106 configured to provide a return current path. One or more grounds may be coupled to a metal chassis within the outlet, or they may be provided from the power source 130.

The switch 112 may be coupled to a processing system 118. The processing system 118 is broadly intended to refer to any controller, control circuit or set thereof, microcontroller, processor, programmable array logic or other circuit, whether using code or dedicated hardware, for executing logic or basic commands as described below. The processing system 118 may include, for example, a central processing unit (CPU) 157, memory 125, and interface circuit 159 for receiving and transmitting signals from various sources (e.g., Bluetooth transceiver 120 or via an internal bus, etc.). The processing system 118 may include, as noted, one or more CPUs 157. CPU 157 may be implemented in practice using one or more processors, digital signal processors, application-specific integrated circuits (ASICs), commercial off the shelf processors, or any suitable processing circuit(s). Memory 125 may include any one or more of dynamic random access memory (DRAM) or static random access memory (SRAM). Memory 125 may alternatively or additionally include flash memory, read only memory (ROM), PROMs, EPROMs, EEPROMs, and the like. Memory 125 may also include various removable flash memory modules using any available standards (e.g., SDXC memory). Memory 125 may be non-volatile, or it may include a volatile portion such as a cache memory or DRAM. In various embodiments, the memory 125 is integrated with a housing of the adapter module. In some embodiment, memory 125 may be integrated with the processing system 118.

In an embodiment, processing system 118 may include basic operating system code for executing the various instructions needed for communicating with one or more devices over a network. For example, processing system 118 may be coupled to a Bluetooth low energy (BLE) transceiver 120 and may be configured to transmit and receive BLE signals to and from BLE transceiver 120 via antenna 137 to and from a user device. In other or additional embodiments, processing system 118 may be implemented with a more sophisticated operating system.

While adapter module 102 uses BLE transceiver 120 for communicating with a user as described herein, in other embodiments the adapter module 102 may be configured to include cellular capability (e.g., 3G, 4G, 5G, etc.), WiFi 802.11 capability, or another wireless network capability. Processing system 118 may receive external communications via interface circuit 159, BLE transceiver 120 and one or more antennas 137 regarding subject matter such as identification of the power source 130 for which service is requested, payment for use of the power source 130, such as confirmations that payment has been tendered, requests for authorization, and the like. For purposes of this disclosure, the specific sequence of actions that the user, vendor server, and adapter module 102 take may differ depending on the configuration and the type of code provided the adapter module 102 or the vendor server.

For example, payment can be tendered in some embodiments even though the actual external transfer of funds or credit may not have been made. Confirmation of payment more generally refers to any reasonably sufficient indication that payment has in fact been made, even if the transaction is pending at the actual bank. In various embodiments and depending on available levels of desired security, for example, the scope of the confirmation may be different. In various embodiments, different forms of coding or cryptography may be used in the mobile application, vendor's server, adapter module 102, or associated financial institutions during the respective communications to ensure the integrity of the transaction and prevent fraud.

Adapter module 102 may further include outputs 104 and 106, e.g., in the form of a NEMA or equivalent outlet. In an embodiment, a corresponding hot wire 104 and corresponding neutral wire 130 provided from existing power source 130 may be routed from respective wires 108, 110 through the switch and made available to the customer. Where a simple three prong unit is used, the hot and neutral wires 104 and 106 may be coupled to an electrical outlet associated with the existing power source 130, with a ground wire GND connected to a metal chassis in the power source and/or otherwise acquired from the power source (130). During installation the existing power source 130 may include a casing that can be opened. The adapter module 102 can thereupon be inserted inside the casing and coupled to bypass the existing wiring, with the output hot and neutral wires 104 and 106 coupled to the power outlet into which a user can connect a plug. The plug can be a standard plug, a USB interface, or any proprietary interface to receive a standard AC signal or a dedicated DC signal. Ground output 107 is also shown. As noted above, the ground output 107 may use a body within the existing power source 130, or an alternative ground body made such as a metal chassis available via the adapter module 102.

The adapter module 102 may be a unit with a protective outer casing. In other embodiments, to minimize size and cost, the adapter module 102 may be a simple printed circuit board that uses commercial off the shelf (COTS) integrated circuits and standard plugs to accommodate the existing wiring and electronic circuitry needs specific to the power source 130.

As noted, the adapter module 102 may be configured to provide different types of power, depending for example on factors including the geographical region, whether a DC source is desired (e.g., a USB-compatible port for charging mobile devices), or whether a specific type of device is anticipated for connection (e.g., a laptop computer versus a vehicle). In an embodiment, the switch 112, wiring, and circuitry of adapter module 102 is configured to accommodate one or more types of NEMA (National Electrical Manufactures Association) outlets, or equivalents thereto. In other embodiments, as noted, the adapter module 102 may provide other sources. For example, the adapter module 102 may be configured to simply use the outlet type that is present in the wall, thereby eliminating the need for the vendor to make substantial changes above and beyond inserting the adapter module 102 into the casing and bypassing the wiring as described.

To enable the vendor to use the existing equipment, the adapter module 102 may be retrofit with an existing infrastructure as noted above. In one embodiment, an ultra-portable adapter module 102 may be used such that the casing of a power receptacle may be opened with a screwdriver, and at least the hot and neutral wires re-routed inline through the adapter module 102 and back again out of the adapter module 102 through the existing electrical outlet(s).

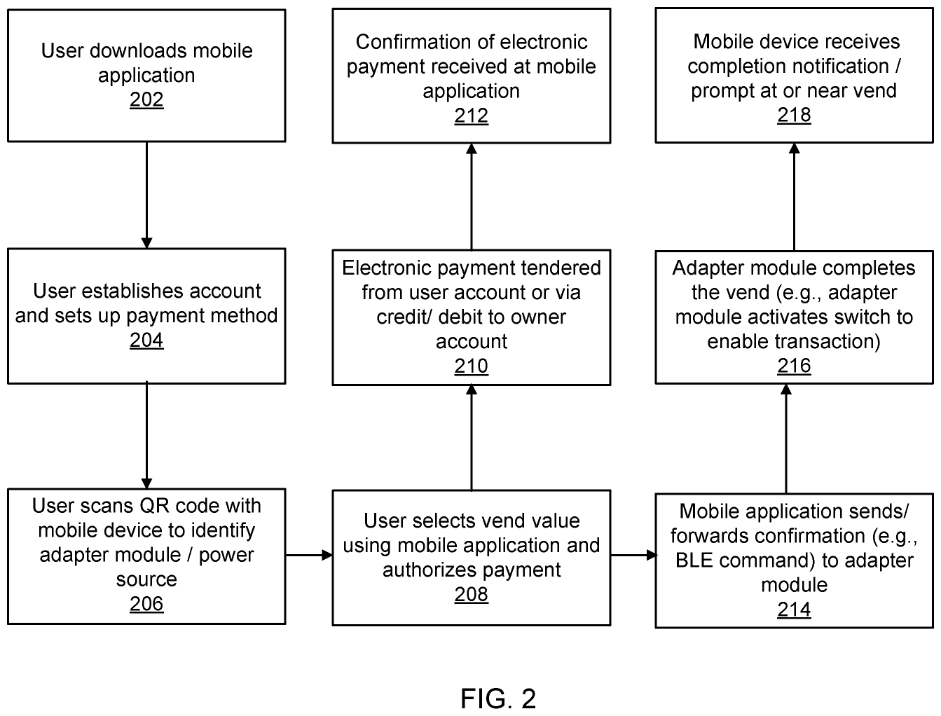

FIG. 2 is a flow diagram describing a process for using the adapter module to receive a vend for a power source, in accordance with an embodiment. At step 202, a user of the prospective service (such as, for example, the power source 130 illustrated in FIG. 1) downloads a mobile application that can be used to activate the adapter module 102 installed in or adjacent the power source or other device. The mobile application may be used to activate an account at a vendor's server over the internet, regardless of the connection type. In an embodiment, the mobile application can communicate with the vendor's server via a wireless cellular connection (e.g., 3G, 4G, 5G, and the like), whether directly or through another network (e.g., WiFi, Bluetooth, an IR connection, etc.). In step 204, the user establishes an account with the vendor and sets up a payment method. This can be done per use of standard prompts provided by the vendor's server. In an embodiment, the user can provide a credit card number. In some embodiments, the user may also be given the choice to use one or more third party payment services like PayPal™ or Zoom™ In other embodiments, the user may be prompted to enter bank account information for direct transfers. In this manner, the user can purchase vended products or services without the need for cash or coins or bills, and may simply use a mobile phone or similar portable device to consummate a vending transaction. The account may include a personal account associated with the customer/user, and money can be added to the account or used for service as desired by the customer/user.

The user now has an account and can make simple wireless payments to use authorized vending services from the provider. In an embodiment, the user has a personal account that is maintained at the vendor server in which funds can be withdrawn at will to use any power source that is serviced by the vendor. In an exemplary embodiment, the user can add funds to the account using an external bank account, credit or debit cards, or a third party payment technique, or combinations of the above. The details of the account and payment can largely be conducted on an encrypted conduction over the network, and many different implementations are possible without departing from the spirit or scope of the present disclosure.

In an embodiment, the vendor may use a personal server computer (or plurality thereof) to effect these transactions, or the vendor may outsource these functions to a third party. The vendor's server can communicate with authorized users over the internet. The vendor's server can also send messages to the user's mobile device via the installed mobile application, which messages can be forwarded to the adaptor module. The messages may be modified by the mobile application if authorized, or they may be directly routed via the BLE transceiver 120 to the adapter module 102 (FIG. 1). For example, the messages can be encrypted messages decipherable by the processing system 118 including confirmations that a payment has been tendered, the amount of the payment, the type of service or the length of service desired, etc. In an embodiment, the adapter module can be programmed at the factory or by a vendor to accept certain commands or implement specific protocols. Alternatively or additionally, the vendor may purchase a pre-equipped software system along with the adapter modules to use in connection with one or more power sources on the vendor's properties.

Referring still to FIG. 2, at step 206 the user may scan a QR code that is placed proximate the power source. The vendor may place the QR code sticker, for example, directly on the casing of the power source, on a wall adjacent the power source, or generally in a location that is sufficiently conspicuous to a user such that the user readily associates the QR code with the power outlet. In other embodiments, a QR code may not be used and the user may instead enter a specified code or machine/power source identifier on the mobile application installed on the user's mobile device. The information including the QR code may be transmitted to the vendor's server, informing the vendor that a prospective customer desires to use the power outlet, e.g., to charge a notebook computer or the user's mobile device, etc.

At step 208, the user may additionally enter a vend value. In an embodiment, the vend value may be a selection of input prices that relate to the duration the power source is to be active. A number of possible values and corresponding outlet use durations may be shown onscreen at the mobile application from which the user can choose. Alternatively, the user may be prompted to manually enter a custom time duration, after which a total cost can be provided. The user selects the appropriate prompts to authorize payment.

At step 210, upon the user authorizing payment, an electronic payment is tendered as described above, such as via the user's personal account, a credit card or other pre-established forms of payment provided by the user when the user initially downloaded the mobile application and signed up for the service. The payment form may alternatively be automatically selected by the user on the fly, when service is desired. The vendor's server or an outsourced entity may handle the financial transaction and notify the vendor accordingly. After receiving information that payment has been made and the amount of the payment, the vendor may send a confirmation to the user's mobile device that a payment of a specific amount has been tendered, which is received at the mobile application (step 212). The mobile application may provide an electronic confirmation to the user along with information about the payment and the duration of time purchased. The mobile application, in turn, may forward the confirmation or otherwise provide independent confirmation to the adapter module 102 via the BLE transceiver 120 and antenna 137 that the payment has been tendered and the details of the service, as applicable (step 214).

In an embodiment, the power source may be rented for general use, to plug in any device for a specified time, for example, Alternatively, a user may select an input corresponding to “charge the device” or a like phrase, in which case the processing system 118 (FIG. 1) may be configured to activate the switch 112 to enable a current flow to the outlet that continues to supply power until a current sensor or other device provides information determining that the device is fully charged. In accordance with this embodiment, the processing system 118 may be equipped with a default setting whereby the charge is additionally terminated upon the user's disconnection of the device, or when a predetermined time has passed and the processing system 118 is unable to determine whether a full charge has been effected.

At step 216, having received the confirmation, the processing system 118 proceeds to activate switch 112 to enable a voltage/flow of current to the power outlet for the prescribed time. The adapter module may use the BLE transceiver 120 to periodically notify the mobile application regarding the amount of time that the power outlet will remain active. In alternative embodiments, this information is passed over a wireless network to the vendor's server, which in turn can alternatively or additionally be responsible for providing reminders or updates to the mobile application. For example, the notification may include an optional prompt to purchase additional time to use the power source before the current flow expires. At step 218, the mobile devices receives a message of completion (e.g., from the adapter module 102 or the vendor server) when the provision of service has ended.

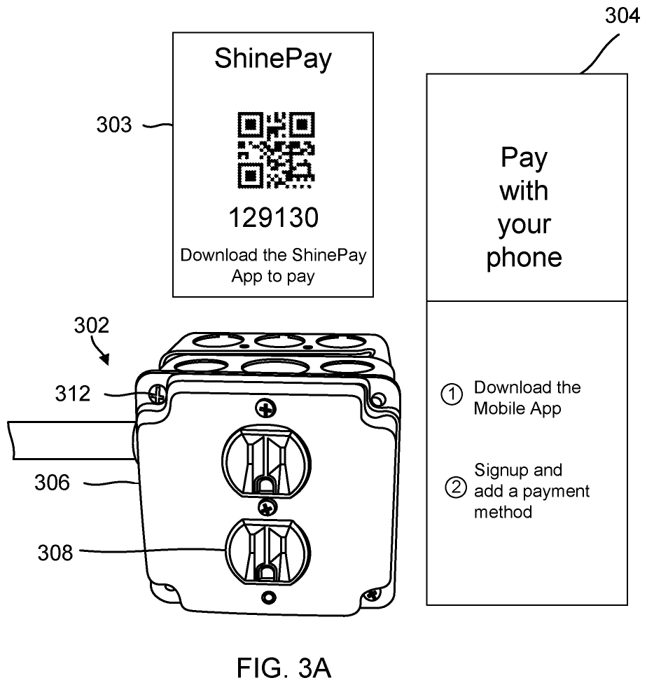

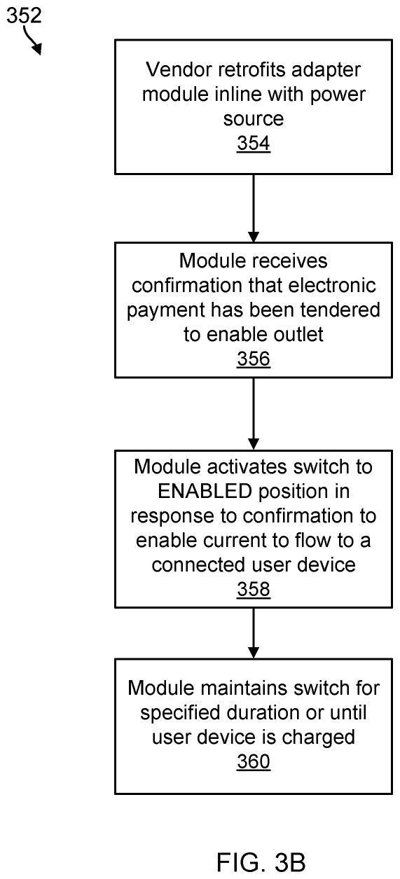

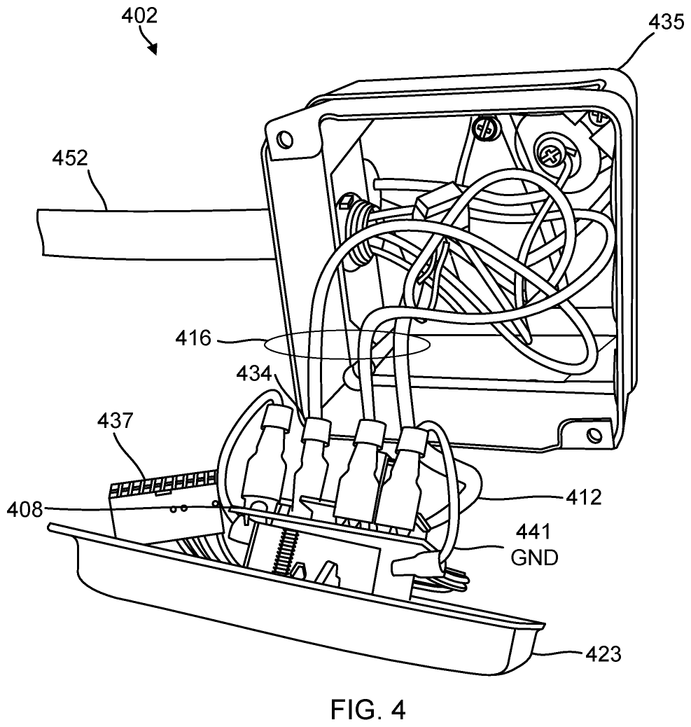

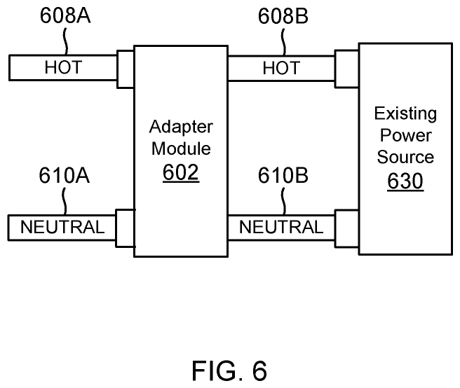

FIG. 3A is an illustration of a power source 302 that a user can access via a mobile device application to power a user device. Power source 302 includes a standard casing 306 and electrical outlets 308. In an embodiment, the casing 306 is opened by removing the screws 312 in a manner known to those skilled in the art, after which the adapter module can be retrofit inline with the existing wires, as further described below with reference to FIGS. 4 and 6.

To provide an identifier for the power source 302 and/or dedicated electrical outlets in accordance an embodiment, a message 303 including a QR code and information regarding a specific mobile application may be placed proximate the power source 302. Instructions 304 may also be included to identify to a user simple steps to using the electrical outlets by downloading a mobile application. The vendor can provide more specific information on the message 303 or instructions 304 about the name of the company and the URL of the website, if desired.

FIG. 3B is a flow diagram of a method for installing and operating an adapter module with the power source of FIG. 3A. The vendor retrofits an existing adapter module inline with the desired power source (354). Thereupon, the power source is operational and the vendor can provide links to its mobile application to enable prospective customers to use the outlet(s) to connect an external device. After a user signs on to his or her account and enters the appropriate payment information and desired time, the information is sent to the web server. That information can be processed by the web server and a confirmation can be sent to the adapter module that payment has been made to borrow the outlet, whether directly or via the mobile application (356). Upon receiving confirmation, the processing system of the adapter module may activate the switch to enable the power outlet to provide a current to a user device connected thereto (358). The adapter module thereafter maintains the state of the switch in an ENABLED state for the specified duration of the use, which in some embodiments may be until a time when the user device is charged (360).

FIG. 4 is an illustration of an open power source 402 with an adapter module 408 retrofit inline therewith, in accordance with an embodiment. The front cover 423 of the power source 402 has been removed to reveal the casing 435 and make accessible the existing wiring. While a standard North American power outlet is shown in this example, in other examples the module may be retrofit with a circuit using another standard, or a DC power source. Cable 452 provides power source 402 with power routed from a central circuit breaker or other dedicated location.

In FIG. 4, the three wires 416 originating from the cable 452 may represent two hot wires and one neutral wire, where each of the two hot wires are used to connect to separate power outlets in the power source 402. The third wire in 416 may represent a neutral wire to provide a return current path. The neutral wires may be tied together within a portion of the casing 435. In normal operation (i.e., without adapter module 408), the hot and neutral wires 416 are coupled to corresponding contacts dual power outlets to provide the AC current and the return path. When installing adapter module 408, one of the hot wires 416 and a neutral wire 416 may be disconnected from their respective serial outputs to the dual outlets and instead fed inline to two respective inputs of adapter module 434. In this embodiment, adapter module 408 is a printed circuit board populated with two input and two output interface plugs (one for hot and one for neutral) for a total of four connections respectively receiving and outputting the power, and processing circuitry (see FIG. 1). The adapter module also includes two ground connections 441 where the ground is coupled to a metal chassis within the casing. The ground connection 441 may also be provided to a third prong of a three-prong outlet. In various embodiments, the adapter module 408 may also include a second hot wire input for providing an inline connection to the second power outlet.

In other embodiments, the adapter module 408 may include a housing, particularly where additional signal isolation is desired to increase signal-to-noise ratio. Ground wires 441, as noted, may be clamped to a metal chassis arranged on an inner service of the front cover 423. Adapter module 408 further includes outputs for the hot and neutral wires (partially obscured from view) that are coupled to the respective contacts on the power outlet to be used. In an embodiment as noted above, adapter module 408 may be configured to connect to both outlets, in which case different identifiers may be assigned to each outlet (e.g., via different QR codes or internally using code in the memory of the adapter module) to differentiate the outlets when in service. In an embodiment, one or more LED lights may be installed on adapter module 408 to indicate that the connections have been successfully made or to provide an indication that the adapter module is operational, etc.

After adapter module 408 is fit and the wires are correctly routed, front cover 423 may be closed, and the power source 402 is ready to be used by individuals that download the associated mobile application. As noted above, each power source 402 and/or power outlet can be associated with a unique identifier to enable the mobile application to communicate to the vender's server as to which outlet is being requested. The identifier may be included in the QR code described above, or by manual entry of a machine ID. The use of the QR code is a matter of convenience, and in other embodiments, the identifier may be conveyed using alternative means. For example, the user may be prompted to enter data that includes both payment and identification information.

In one embodiment referenced above, the adapter module may be used to charge a user device, such as to add power to the user's mobile device or tablet PC, for example. The adapter module may include a current sensor 114 (FIG. 1) or other hardware detection device that measures the current or load on the outlet to determine whether and to what extent a device is charged (e.g., FIG. 1). The processing system 118 (FIG. 1) may use this information to divine whether additional charging is needed, and when the device is fully charged. In this manner, the adapter module 203 may be used to charge a portable device and to automatically disable the switch to turn off the power after a device has been fully charged. In other embodiments, the device to be charged may be a vehicle, for example, and need not be limited to a portable device.

In some embodiments, the adapter module and/or mobile application may include additional code to specify details such as whether the service is to be provided on a time basis (e.g., a minute-by-minute or hourly basis, etc.) or whether the service can be used to charge a device (regardless of time duration of the charge). In these implementations, adapter module may use additional circuitry or code to prompt a device when to connect and disconnect, and to indicate whether the charge was successful or an error was identified in connection with the charging process.

Generally, the retrofit procedure can be performed quickly and seamlessly. While in the embodiment described above, the adapter module is configured to selectively couple an existing power source with its output, in other applications an adapter module may be retrofit in an existing DC power source or a different standard source that lacks a built-in payment collection. In the latter embodiments, the adapter module may function using a similar switch to authorize the outlets to operate, and may be retrofit in a generally similar manner that uses existing power source wiring to accomplish the inline retrofit in a manner appropriate for the governing standard.

An example of one such embodiment is a USB charging mechanism. It is often the case that USB ports are available in general, but are not equipped to accept payment, such as with most consumer USB outlets from computers or built into other structures on a property. This limitation circumscribes the total income a vendor can expect to obtain when making these products available to public users for a fee.

Accordingly, in another aspect of the disclosure, an adapter module may be retrofit inline with such USB ports or other standard electronic data or power sources on the vendor's property or otherwise controlled by the vendor, to enable the vendor to assess a service fee. A small form-factor adapter module may be provided. The adapter module includes, in most configurations, industry standard connector interfaces specific to the USB or other electronic device, as well as the processing system, switch, wireless network, and other interface logic similar to those identified in FIG. 1. Certain components may not be necessary (e.g., a current sensor) and may be replaced if necessary by amplifiers, filters, or other conventional electronics. The adapter module in this embodiment, however, may be coupled to additional or different conductors that are used for data or that are otherwise specific to the governing standards of the devices being used. To this end, the vendor may supply a website (or outsource such a function to a third party for managing the website) that supplies a download for a mobile application to enable the user to borrow power outlets or other NEMA standard ports, USB ports, etc. that have modules retrofit therein. The vendor may also apply a QR code and basic instructions in a conspicuous region proximate the power source or data source to facilitate identification by a mobile device.

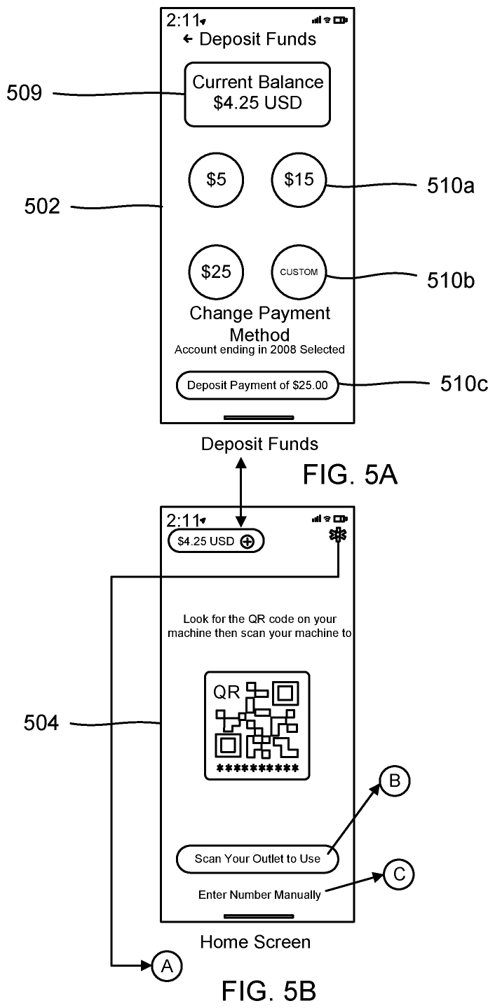

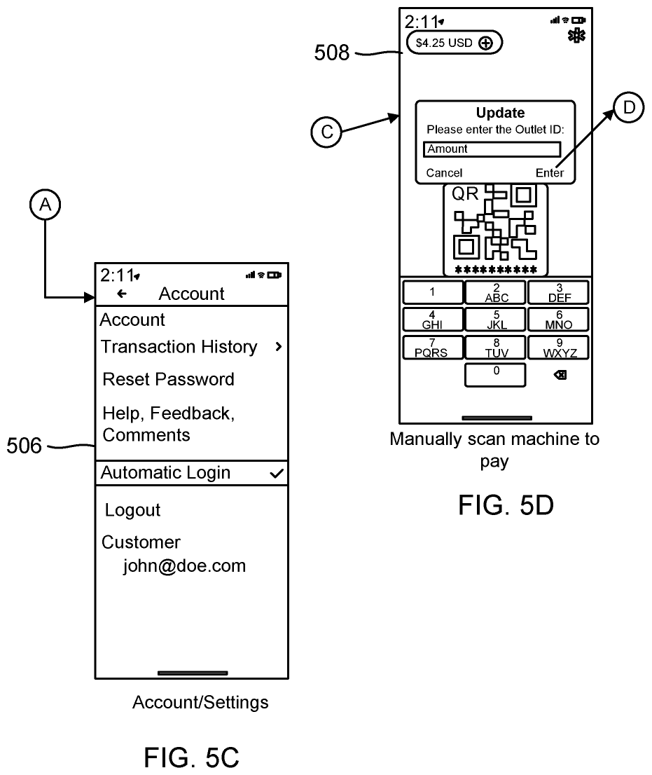

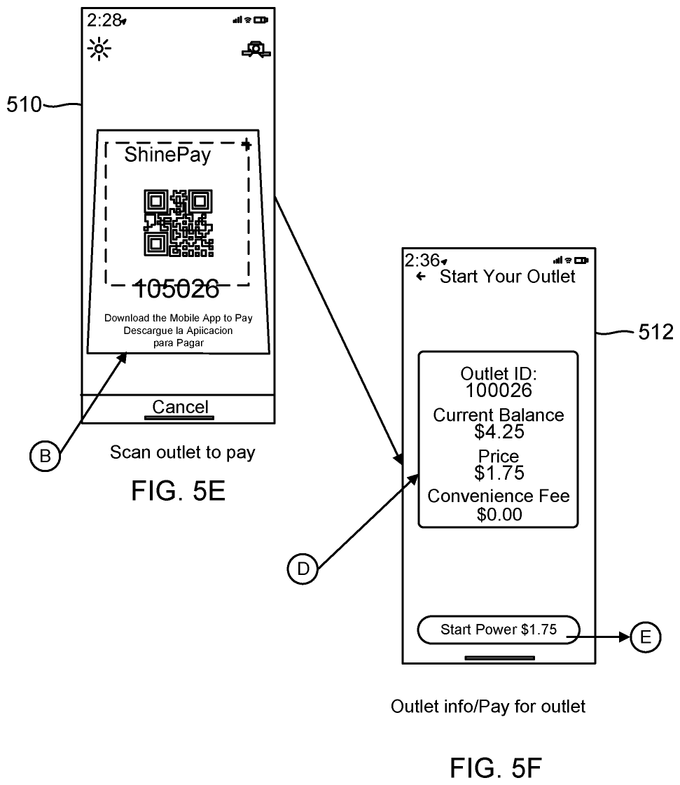

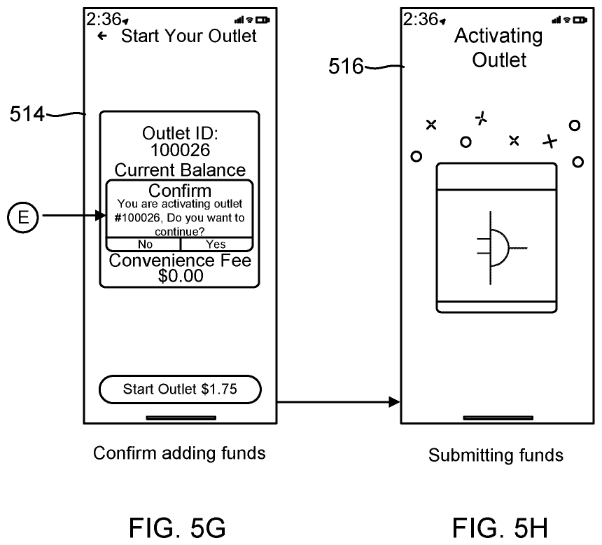

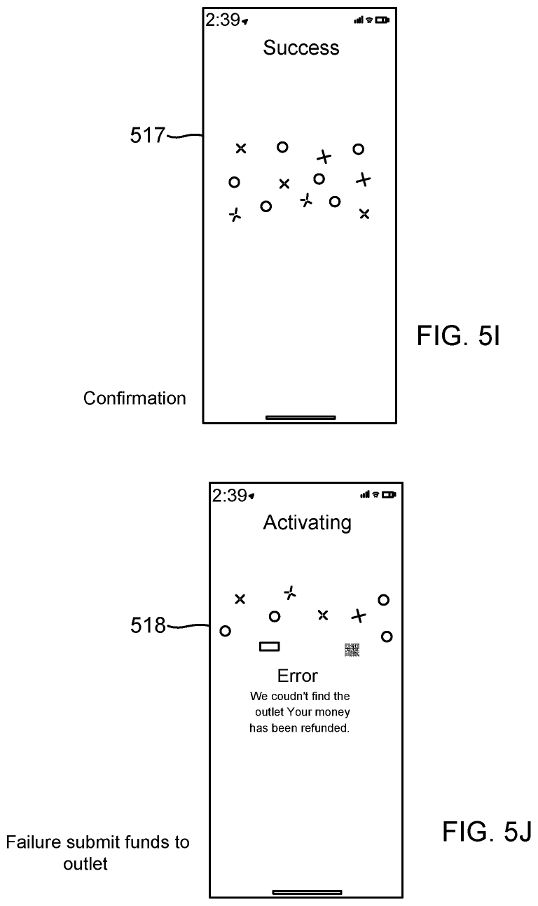

FIGS. 5A-I are a flow diagram depicting exemplary features on a mobile application as seen on a mobile device for enabling a user to receive a vended power source, in accordance with an embodiment. In particular, FIGS. 5A-I illustrate a mobile application display in an embodiment in which services for power are provided in exchange for a fee. It is assumed that a user has visited the vendor's website and has downloaded the specified mobile application. Upon signing in, the user may be shown a home screen 502 (FIG. 5A) in which the amount of funds 509 in the user's account is displayed. In an embodiment, the home screen may also include standard or custom prompts for enabling the user to expediently add funds to the account using predetermined (510a or 510c) or custom (510b) amounts. The user may receive additional prompts to deposit funds.

FIG. 5B shows an example of a subsequent prompt after the user has selected an entry to obtain vending services. The mobile application may prompt the user to pair the mobile device with the adapter module, and a Bluetooth connection or other wireless connection may be established. The user may also access settings or preferences in the mobile application by selecting the icon shown as (A). The mobile application may return a screen 504 that prompts the user to scan the available QR code in the vicinity of the machine to be used. It should be noted that part or all of the displays provided to the user via the mobile application may be provided as scripts or other code from the vendor's server. Alternatively, part or most of the relevant code may be present on the user's mobile device. The specific software methodology is flexible and different configurations can be provided. Referring still to FIG. 5B, the home screen may prompt the user to enter a manual identifier of the power outlet (C), or to scan the code present on or adjacent the outlet (B).

The identification of the device may be provided to a vendor's server, which may in turn forward a code or other authorization to the adapter module via the mobile application. Having received authorization to operate the power outlet for a specified time duration, for example, the processing system may activate one or more switches to render the outlet operational for a cycle, or for a time or amount identified by the user.

The mobile application may include other features as noted herein. Referring to FIG. 5C, the settings icon (FIG. 5B) may lead the user to specific account information 506 with settings such as automatic login, e-mail preferences, contacting the vendor, etc. FIG. 5D shows a screen 508 in which the user manually enters a specified identifier of the power outlet, as described above.

FIG. 5E may provide a screen 510 which assists the user in aligning the QR code in an area (B) to complete the scan. Thereafter, upon authorization, a list of items (D) relevant to the vend may be portrayed (FIG. 5F) in screen 512, such as the outlet ID, the current balance on the user's account, the cost for a cycle of service, and any convenience fee that the vendor may decide to assess to consummate the transaction. When the mobile application is authorized by the server to activate the adapter module, a prompt may appear such as “start your outlet” (E) in screen 512 of FIG. 5F. In some embodiments, the mobile application may further display a screen 514 prompting the user to confirm the activation of the power source, as shown in FIG. G (E). When the funds are submitted and the device is operational, the mobile application may so inform the user as to the activation and/or status of the power source by showing an illustrative screen 516 (FIG. 5H) or a success indication (517) (FIG. 5I).

The mobile application may provide a success screen 517 (FIG. 5I) if the power supply is operational. Further, in an embodiment, if an error is encountered with the operation or the machine identifier is not recognizable for whatever reason, the mobile application may return a screen 518 that identifies that an error has occurred and that the user's money has been refunded (FIG. 5J).

It will be appreciated by those skilled in the art on perusal of this disclosure that the foregoing steps are exemplary in nature. Some of the steps may occur in different sequences, and other steps may be omitted. Further, the disclosure is not intended to be limited to the washing and drying services and the features described herein may be applicable to a wide array of products and services. For example, existing vending machines for food and beverages may be modified by a vendor to obviate the need for coins and bills, or to augment such machines with automatic pay capabilities such as those described herein.

FIG. 6 is a block diagram describing the structural adaptations that are made to an existing power source. In particular, hot and neutral wires 608A, 610A are present in the existing infrastructure and provided to existing power source 630. The adapter module 602 and the bypassed hot and neutral wires 608B, 610B are the only changes needed to effect the provision of power as described herein. A similar result occurs with reference to the use of virtually any conventional coin-operated device, with the electronics on the adapter module being modified accordingly to inter-operate correctly with the specific device in use. The vendor in some embodiments may choose to populate a large number of machines with this capability, which in turn may give rise to a substantial profit without incurring the intensive capital associated with purchasing new equipment and developing new product and service infrastructures from the ground up.

The previous description is provided to enable any person skilled in the art to practice the various aspects described herein. Various modifications to the exemplary embodiments presented throughout this disclosure will be readily apparent to those skilled in the art, and the concepts disclosed herein may be applied in other contexts and for different purposes. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for providing a power source for a user device, comprising:
retrofitting an adapter module inline with the power source, the adapter module comprising a switch that, when off, maintains an outlet corresponding to the power source in a disabled state;
receiving, from the user over a network, confirmation that an electronic payment has been tendered to enable the outlet; and
activating automatically the switch to an on position in response to the confirmation to thereby enable a current to be received by the user device coupled to the outlet.

2. The method of claim 1, further comprising activating the switch to enable the current flow for a time proportional to an amount of the payment.

3. The method of claim 1, further comprising receiving, from a mobile application on the user device, a QR code at a server device, the QR code being affixed proximate the power source for scanning by the mobile application.

4. The method of claim 1, wherein the power source comprises at least one of an alternating current (AC) and a direct current (DC) power source.

5. The method of claim 1, further comprising converting by an AC-DC converter in the adapter module an alternating current (AC) power source to a DC power source.

6. The method of claim 1, wherein the network comprises one or more of a Bluetooth, Wi-Fi or cellular wireless network.

7. The method of claim 1, further comprising:
sensing a value of the current using a current sensor to determine an amount the user device has been charged; and
turning the switch off upon detecting that the sensed indicates that the user device is charged.

8. The method of claim 1, wherein the user device comprises a vehicle.

9. The method of claim 1, further comprising receiving an identifier (ID) from a mobile application on the user device, the ID being sufficient to identify the outlet.

10. The method of claim 9, wherein the ID comprises a QR code scanned by the user device.

11. The method of claim 1, wherein the power source comprise a NEMA connector.

12. The method of claim 1, wherein the retrofitting the adapter module comprises installing the adapter module with in series with the outlet.

13. An adapter module retrofit inline with a power source for providing power to a user device, the adapter module comprising:
a processing system for controlling a switch that, when off, maintains an outlet of the power source in a disabled state; and
a wireless transceiver coupled to the processing system for receiving confirmation from a user over a network that an electronic payment has been tendered to enable the power source,
wherein the processing system automatically activates the switch to an on position based on the received confirmation to thereby enable a flow of current to be received by the user device coupled to the outlet.

14. The adapter module of claim 13, wherein the processing system is further configured to activate the switch to enable the current flow for a time proportional to an amount of the payment.

15. The adapter of claim 13, wherein the adapter module is associated with an identifier (ID), the ID comprising a QR code affixed proximate the power source, the processing system being further configured to receive the QR code from an application on the user device and to forward the QR code to a server device to which the electronic payment has been tendered.

16. The adapter module of claim 13, wherein the power source comprises at least one of an alternating current (AC) and a direct current (DC) power source.

17. The adapter module of claim 13, further comprising an AC-DC converter that converts an alternating current (AC) power source to a DC power source.

18. The adapter module of claim 13, wherein the network comprises one or more of a Bluetooth, Wi-Fi_33 or cellular wireless network.

19. The adapter module of claim 13, further comprising:
a current sensor configured to sense a value of the current for determining an amount that the user device has been charged,
wherein the processing system is configured to disable the switch upon detecting that the value of the current indicates that the user device is charged.

20. A method for providing power or data services to a user, comprising:
retrofitting inline an existing power or data device with an adapter module for providing a corresponding power or data service for a fee, the adapter module comprising a switch that, when off, maintains the device in an idle state;
receiving, from a user device over a network, information comprising an indication that an electronic payment has been tendered for the data or power service; and
activating the switch responsive to the information to enable providing, by the device, the data or power service.
